(19) United States
(12) Patent Application Publication
(10) Pub. No.: US 2012/0089494 A1
(43) Pub. Date: Apr. 12, 2012

(54) Privacy-Preserving Metering

(75) Inventors: George Danezis, Cambridge (GB); Alfredo Rial Duran, Cambridge (GB)

(73) Assignee: Microsoft Corporation, Redmond, WA (US)

(21) Appl. No.: 12/901,214

(22) Filed: Oct. 8, 2010

(51) Int. Cl. G06Q 30/00; G06Q 40/00

(52) U.S. Cl. 705/34; 705/40

(57) ABSTRACT

Privacy protecting metering is described such as for electricity, gas or water metering, metering use of cloud computing resources, traffic congestion charging and other metering applications. In examples, fine grained user consumption data is kept private and not disclosed to a provider of a resource consumed by the user. In examples, a bill generator receives certified meter readings and a certified pricing policy and generates a bill which omits fine grained user consumption data. For example, the bill generator generates a zero knowledge proof that the bill is correct and sends that proof to a provider together with the bill. In examples a provider is able to check that the bill is correct using the zero knowledge proof without finding out the user's private consumption data. In an embodiment the pricing policy is stored as signed rows of a table to enable efficient generation of the zero knowledge proof.

### BACKGROUND

Metering is involved in many application domains such as electricity metering, water metering, gas metering, pay as you drive car insurance, traffic congestion charging, on-line services metering such as pay-per-view digital rights management, software as a service metering and others. However, as the sophistication of the metering increases there are concerns about user privacy protection. For example, it may be possible, through fine grain electricity meter readings, to identify which electrical appliances are used through load monitoring. Detailed consumption data may facilitate the creation of users' lifestyle profiles, with information such as when they are at home, when they eat, whether they arrive late to work and so on. User privacy concerns arise where there is metering in other application domains. For example, pay-as-you drive car insurance, tolling or taxation based on the time, distance and location of a vehicle may potentially make that fine grained information available to providers.

Existing approaches for protecting user privacy where metering is carried out are typically administrative, for example, being based on codes of conduct, regulations and legislation.

Other solutions for protecting users' privacy have involved enabling groups of users living in the same neighborhood to compute the sum of their consumption without disclosing their individual consumption. However this type of approach is complex and relies on collaboration between users in the group.

The embodiments described below are not limited to implementations which solve any or all of the disadvantages of known privacy-preserving metering systems.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Privacy protecting metering is described such as for electricity, gas or water metering, metering use of cloud computing resources, traffic congestion charging and other metering applications. In examples, fine grained user consumption data is kept private and not disclosed to a provider of a resource consumed by the user. In examples, a bill generator receives certified meter readings and a certified pricing policy and generates a bill which omits fine grained user consumption data. For example, the bill generator generates a zero knowledge proof that the bill is correct and sends that proof to a provider together with the bill. In examples a provider is able to check that the bill is correct using the zero knowledge proof without finding out the user's private consumption data. In an embodiment the pricing policy is stored as signed rows of a table to enable efficient generation of a look-up in zero-knowledge.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a privacy protecting metering system;

FIG. 2 is a flow diagram of a method at a privacy protecting bill generator;

FIG. 3 is a flow diagram of a method at a provider for verifying a privacy protecting bill;

FIG. 4 is a schematic diagram of a metering system for a computing resource such as a cloud computing resource;

FIG. 5 is a flow diagram of a method at a privacy protecting bill generator for use in a metering system where the meter is trusted to leak no more information than meter readings;

FIG. 6 is a flow diagram of a method at a provider for use with the method of FIG. 5;

FIG. 7 is a schematic diagram of a metering system for a utility where a meter provides certified readings at public fixed time intervals;

FIG. 8 is a flow diagram of a method of generating a privacy protecting bill in situations where a meter provides certified readings at public fixed time intervals;

FIG. 9 illustrates an exemplary computing-based device in which embodiments of a smart meter or bill generator or bill verifier may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a smart metering system, the system described is provided as an example and not a limitation. As those skilled in the art will appreciate, the present examples are suitable for application in a variety of different types of metering systems.

In the examples given below cryptographic techniques are used to protect users' privacy in metering applications. Some terminology from the field of cryptography is now explained, at a high level without formal mathematical definitions, to aid understanding of the examples.

A commitment scheme is a method that enables a sender to commit to a value and send that value to a receiver in such a way that it is hidden from the receiver. The sender is able to reveal the hidden value later. Because the sender has committed to the value, the sender is unable to “cheat” or bias interaction between the sender and receiver by changing the value before it is revealed to the receiver. It is possible to think of a process for committing to a value as for example, putting the value into a box, locking the box and giving the box to the receiver who cannot unlock the box. The sender can't change the value because the receiver has the box. The value is hidden from the receiver because the box is locked. However, the sender can reveal the value by helping the receiver to unlock the box. Instead of using boxes and physical locks analogous mathematical processes may be used to enable the sender to commit to a value. At the reveal stage, the sender may provide opening values which are akin to the key in the above example and enable the receiver to use a mathematical process to reveal or open the commitment.

A homomorphic commitment scheme is one where two commitments formed using the scheme can be combined such that that combined commitment may be opened (or revealed), by combining the opening requirements of the individual commitments. Operations on commitments lead to operations on committed values. More detail about homomorphic commitments schemes is given below.

A zero-knowledge proof is a method between two entities, a prover and a verifier, which enables the prover to demonstrate to the verifier that a statement is true, without revealing anything except the veracity of the statement. For example, in the case of metering applications, a user may wish to prove to a utility company or other provider (verifier) that his or her bill is correct without revealing meter readings to the provider. For example, a zero-knowledge proof may be a three part protocol that allows a prover to convince a receiver that they know some committed values without revealing them. In the first phase the prover generates a set of commitments to random values, one for each of the values it wants to provide knowledge. In the second part, using a one-way function on those commitments to random values, the prover generates a challenge. In the third part, the prover computes a set of responses that are a function of the secret values, the random values and the challenge. The verifier can then ensure that the responses satisfy a public equation to convince itself that the prover knows the secret committed values. To verify a zero knowledge proof of knowledge the verifier, first, given the challenges and the responses from the prover, computes the commitments. Then it calculates anew the challenge and checks if it equals the challenge given by the prover.

A non-interactive zero-knowledge proof is a particular type of zero-knowledge proof in which a prover can prove a statement in zero knowledge to a verifier, by sending a message (for example, the message comprises the challenge and the responses) to the verifier than can then check it. In this way the verifier does not need to send any information to the prover and thus there is no interaction between the prover and verifier.

A digital signature scheme (referred to herein as a signature scheme) is a cryptographic scheme to enable items such as documents, emails, messages or other content to be signed by a sender in a way that enables a receiver to be assured that the content was actually sent by the claimed sender. The signature can be verified by anyone as being valid and is said to be “universally verifiable”. A re-randomizable signature scheme is one where anyone may generate many signatures each slightly different from the other and receiving entities are able to verify that any of those signatures originates from the signing entity. Given a valid re-randomizable signature, anyone (no secrets needed) can generate another valid signature on the same message. This fresh signature is un-linkable to the original signature. A signature scheme may have efficient zero-knowledge proofs of signature posession.

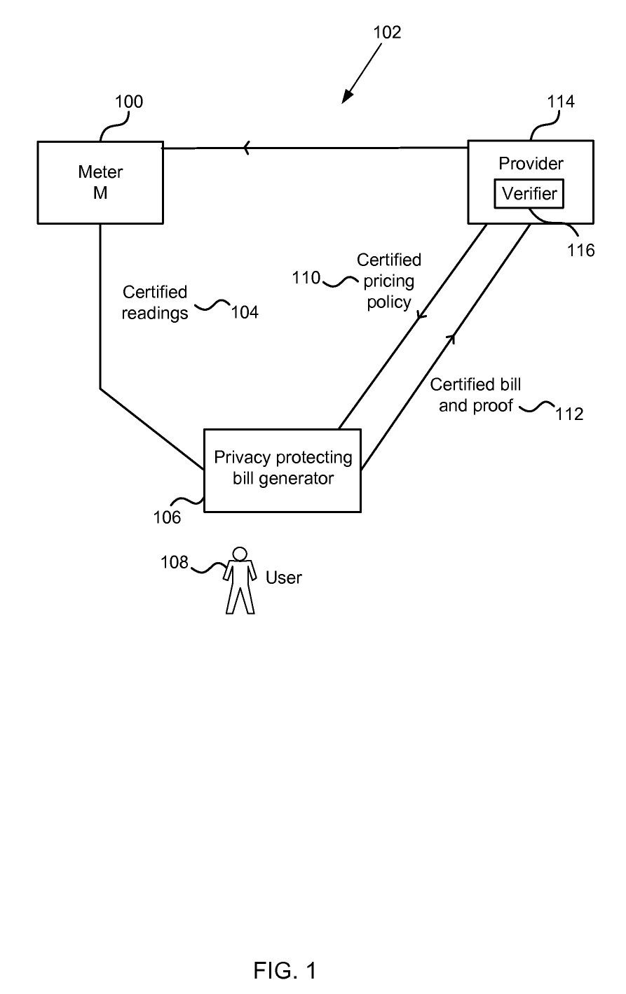

FIG. 1 is a schematic diagram of a privacy-preserving metering system 102. A user 108 consumes a resource which may be any good or service and the consumption is monitored by a meter 100. The resource is provided by a provider 114 which in some examples is able to send communications to the meter 100 (it is not essential for the provider to be able to send communications to the meter). No direct unmediated communication link between a trusted core of the meter 100 and the provider 114 is present in order to protect privacy of the user 108. Direct communication between the provider and other parts of the meter unrelated to metering may be present. For example, to enable the provider to switch electricity provision on and off The meter 100 may be geographically located remote from the provider.

The user 108 has an agent which is illustrated in FIG. 1 as a privacy protecting bill generator 106. This is computer-implemented and arranged to receive certified readings 104 from the meter 100. The privacy protecting bill generator 106 has an input component arranged to receive certified pricing policies 110 or tariffs from the provider. It stores these at a certified pricing policy store. Using the meter readings and the pricing policies the privacy protecting bill generator calculates a bill to be paid by the user 108 to the provider. The calculated bill gives a total amount to be paid and omits detailed meter readings which may prejudice the user's privacy. The calculated bill may contain meter reading details in cases where that is authorized by the user. The privacy protecting bill generator 106 comprises a proof engine to determine a zero-knowledge proof to certify that the bill is correct and sends that proof to the provider together with the bill 112. The bill contains no individual meter readings or only meter readings that have been authorized by the user for release to the provider. Because the proof is zero-knowledge it does not disclose any of the user's consumption data and the privacy of the user 108 is protected. A computer-implemented verifier 116 at the provider 114 receives the certified bill and the proof 112 and verifies that the bill is correct by checking the proof. This verification is achieved without the need for the verifier or provider to access any of the meter readings.

Each of the parties (meter, provider and bill generator) generates a public private key pair and registers its public key at a trusted registration entity. The provider computes parameters for a commitment scheme and sends those parameters to the meter (in examples where the meter outputs commitments to meter readings) and to the bill generator 106.

In the examples described in this document the meter 100 is tamper-resistant. That is the meter is assumed to correctly monitor consumption of the resource and to provide accurate certified readings 104. Because the meter is tamper-resistant, it is difficult for the provider, user, or third parties to alter the working of the meter in an unauthorized manner which could go undetected by the user and/or provider. The size of the meter may be small both physically and functionally since the meter is only required to measure and sign consumption. The meter may be thought of as part of a trusted computing base. The minimal size of this trusted computing base provides benefits for security engineering. For example, it allows for a more thorough evaluation, ease of verification, ease of code reviews, cheaper tamper-resistance and a smaller attack surface.

The privacy protecting bill generator 106 is independent of the meter 100. Therefore the calculation of the final bill can be done outside the tamper-evident enclosure and a variety of policies can be applied and changed with time or as customers change providers, without modifying the trusted computing base. This is beneficial in application domains such as electricity and gas metering where customers often change providers.

In some examples the privacy protecting bill generator 106 and the meter 100 are provided as part of a larger smart-meter that provides a user interface, computes the final bill and associated proofs of correctness and transmits those to the provider. A smart-meter may have a full CPU, displays, local and wide area network telecommunications and remote upgrade capabilities to provide a rich functionality. In this case functions of the smart meter not related to consumption measurements and billing can be performed outside the trusted core. In this case customers need to trust the providers of the smart meter only to transmit the privacy-preserving billing information.

In other examples the privacy protecting bill generator 106 may be implemented using a home server owned by the user 108. This is helpful where customers are reluctant to trust a smart meter. This is also applicable if meters do not communicate directly to the provider, but instead use a customer's equipment for network access.

In other examples the privacy protecting bill generator 106 may be implemented as a third party service such as a web service. This improves robustness to failures or denial-of-service. In this case the user 108 entrusts the third party service with their private data.

In other examples the privacy protecting bill generator 106 is incorporated in a mobile phone or other computing device with WAN connectivity.

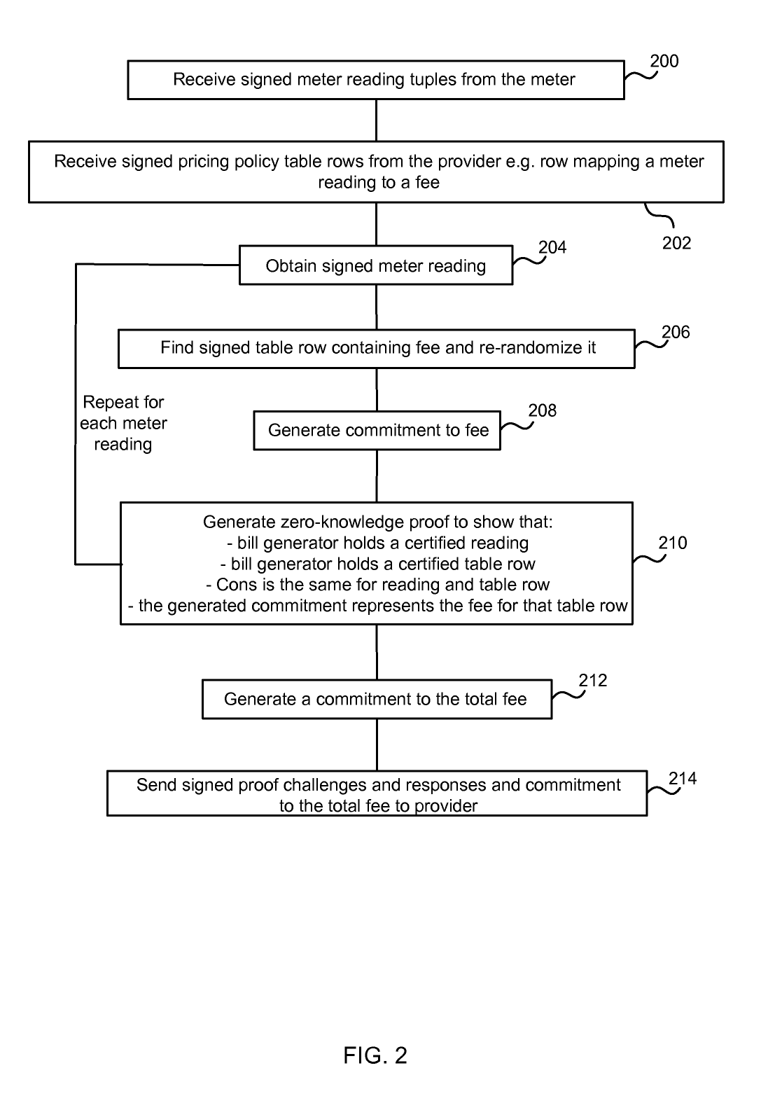

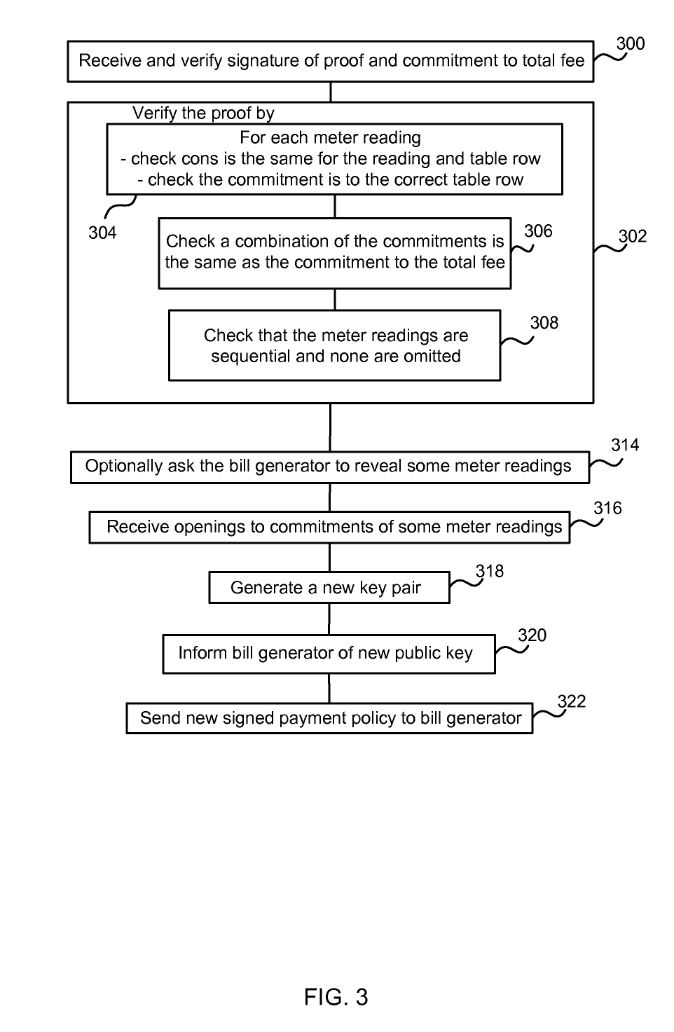

Embodiments are now described in which the certified meter readings 104 provided by the meter are actual meter readings rather than commitments to those meter readings. If the meter outputs certified readings 104 which are commitments to the meter readings then the privacy of those meter readings is enhanced. This is because the commitments output by the meter do not disclose the actual meter reading values until those commitments are revealed. However, in cases where there is a risk of collusion between the provider 114 and the meter 100 at the manufacturing stage, the provider may have colluded with the meter to know how to reveal the commitments output by the meter and find the private meter reading values. To prevent such collusion the meter may be arranged to output signed meter readings rather than commitments to those readings. In this situation the privacy protecting bill generator 106 has a harder job to ensure the privacy of the meter readings since these are provided as actual values and not as commitments. An example of this type of situation is now given with reference to FIGS. 2 and 3.

FIG. 2 is an example of a method at a privacy protecting bill generator and FIG. 3 is an example of a method at a provider to be used in conjunction with the method of FIG. 2. In the examples of FIGS. 2 and 3 the provider issues a discrete pricing policy in the form of a table where each meter reading is mapped to a price or fee f. For example, each meter reading may be the name of a street and the fee may be a toll in the case of a traffic congestion charging application. Other types of pricing policy may be used as described in further examples below.

The bill generator receives and optionally verifies 200 signed meter reading tuples from the meter. Each tuple is a set of three values (d, cons, other) where d is a counter initialized at 0 that is incremented each time the meter output a new tuple. Cons is the consumption meter reading (for example the street name) and other is any other information provided by the meter which influences the fee, such as a time the reading was taken.

The bill generator receives and optionally verifies 202 signed pricing policy table rows from the provider. For example, each row of the table may map a meter reading (e.g. street name) to a fee f. Each row is signed separately.

The bill generator obtains 204 one of the signed meter readings (for example which specifies a street). It then finds 206 the signed table row containing the appropriate fee fᵢ (e.g. the fee for the specified street) and re-randomizes that signed table row. The bill generator generates 208 a commitment to fᵢ and generates 210 a zero knowledge proof to show that:
it holds a certified reading;
it holds a certified table row;
the consumption (cons value) is the same for the reading and table row (e.g. the street names are the same); and
the generated commitment represents the fee for that table row.

As mentioned above the process of forming the zero knowledge proof may comprise three steps. First, generating a set of commitments to random values, one for each of the values the bill generator wants to prove knowledge of Second, using a one-way function on those commitments to random values, the bill generator generates a challenge. Third, the bill generator computes a set of responses that are a function of the secret values, the random values and the challenge. The challenge and responses are sent to the provider which carries out the verification process.

The proof is built as a bit-string that certifies, non-interactively, all the meter readings and the pricing policy information used to form the bill. The proof may be universally verifiable, that is, no secrets are required to verify its correctness. The zero knowledge proof is generated using one or more signatures on information that maps consumption data to prices or fees. However, the verifier at the provider is unable to get any information on which signatures were used to compute the proof. Otherwise, if the provider were to find those signatures, the provider may be able to map from the fees to the consumption data. The zero knowledge proof is generated using one or more building blocks which, in an example, are a non-interactive zero-knowledge proof of possession of a signature, a proof that a committed value is the product of two committed values and a proof that a committed value lies in an interval. Detailed examples of these building blocks are given later in this document.

As described above, the zero knowledge proof comprises proofs that the bill generator holds a certified meter reading and holds a certified table row. That is, the proof shows that the bill generator possesses signatures on a meter reading and on a table row. The purpose of proving possession of a signature in zero-knowledge is that the verifier cannot get any information on which signature was used to compute the proof The verifier only knows that the prover (bill generator) possesses a signature that was signed by the party whose signing public key is utilized to verify the proof In the examples here, the provider P computes several signatures that map consumption values to prices and sends them to the bill generator U. At the end of the billing period, U computes the total fee to be paid and reveals it to P, along with a proof that the total fee is computed correctly. This proof does not reveal to P any information on the consumption data of U. Therefore, U does not reveal to P the signatures (that map consumption values to prices) that were used to compute the fee, because this reveals information on the consumption. To avoid revealing the signatures, U computes zero-knowledge proofs of possession of the signatures, which still allow P to know that those signatures were computed by him, and thus are valid according to the pricing policy.

As described above, the bill generator does not reveal to P the signatures that were used to compute the fee. In the embodiments where the meter is not trusted (i.e. there may have been collusion between the provider and meter at the manufacturing stage) the signature scheme used may be at least partially re-randomizable to provide additional protection against revealing the signatures that were used to compute the fee to P. For example, as illustrated in FIG. 2, the signature of the table row containing the fee and the consumption is re-randomized 206 by the bill generator. Because these signatures are re-randomized by the bill generator before being used to generate the proof there is no risk of them being recognized by the provider. However, it is not essential to use a re-randomizable signature scheme.

This process of generating a commitment to the cost and generating a zero-knowledge proof is repeated for each meter reading. The bill generator forms a commitment 212 to the total cost and sends 214 a signed message to the provider containing the proof challenges and responses and the commitment to the total cost. This signed message comprises either commitments to the policy entries and meter readings, or re-randomized signatures of them. This information is used by the verifier to link the raw commitments (policy fragments and meter readings) to the final cost per reading. The provider proceeds to verify the proof as described below with reference to FIG. 3.

The process at the provider is now described with reference to FIG. 3 except for the process of signing and sending the pricing policy to the bill generator which has been described above.

As mentioned above, in order to verify the zero knowledge proof, the verifier may compute the commitments given the challenges and the responses from the bill generator. Then it may calculate anew the challenge and check if it equals the challenge given by the bill generator.

The provider receives 300 the signed message containing the proof and commitment to the total cost. It verifies the signature on the message and then proceeds to verify 302 the proof. This is done by, for each meter reading:
checking that cons is the same for the reading and table row; and
checking the commitment is to the correct table row.

The provider also checks 306 that a combination of the commitments is the same as the commitment to the total cost and that the meter readings are sequential 308 and none are omitted (otherwise the user could cheat and avoid paying for omitted meter readings). To do this, the provider may know the number of tuples that the meter outputs each billing period (as this information may be public domain). Another possibility is to enable the meter to output, at the end of the billing period, a signature on the amount of tuples that were output at that period. This signature is then reported by the bill generator to the provider.

The provider is optionally able to ask 314 the bill generator to reveal some specified meter readings. If the bill generator permits this, for example, if the user has given authorization, then the appropriate opening details are sent to the provider. The provider receives 316 an opening to those commitments and is able to reveal the specified meter readings.

In some embodiments the provider is able to issue new pricing policies. To ensure that the bill generator uses the most recent pricing policy the provider may generate 318 a new key pair. The bill generator is informed of the new public key and then the new pricing policy is signed with the new key and sent 322 to the bill generator. A validity period may be included in the pricing policy.

In this example the bill generator reveals the total fee to the provider and may pay the bill through an arbitrary payment channel. In some situations the user may also want to hide the total fee. This may be achieved by using a pre-payment mechanism as now described. The user pays an initial deposit to the provider through an arbitrary payment channel. To compute a bill the bill generator commits to the new value of the deposit (i.e. the old one minus the total fee of that billing period), and proves in zero knowledge that the committed value is a correct update of the deposit and that it is non negative, so that the provider can check that the user still has enough funds.

In the examples of FIGS. 2 and 3 the provider issues a discrete pricing policy in the form of a table where each meter reading is mapped to a price or cost c. Other types of pricing policy may be used. For example, a linear pricing policy may be beneficial where the set of possible consumption values is large. A linear policy, instead of specifying the price of each possible consumption, specifies the price per unit. For instance, if the policy says that the price per unit is 3 and the consumption is 6, the price due is 18. In the case of a linear pricing policy there is more to prove and verify by the bill generator and provider. Other examples of types of pricing policy include but are not limited to: interval policies, cumulative policies, and policies defined by a polynomial function. An interval policy sets a fixed cost for a range of consumption amounts. A cumulative policy considers a consumption values domain as divided into intervals where each interval is mapped to a price which is a price per unit of consumption.

By representing different types of pricing policies in these ways the expression of complex non-linear pricing policies is possible. Any policy can be applied for any time interval such as per day, week or month. More details of these types of policies are given below.

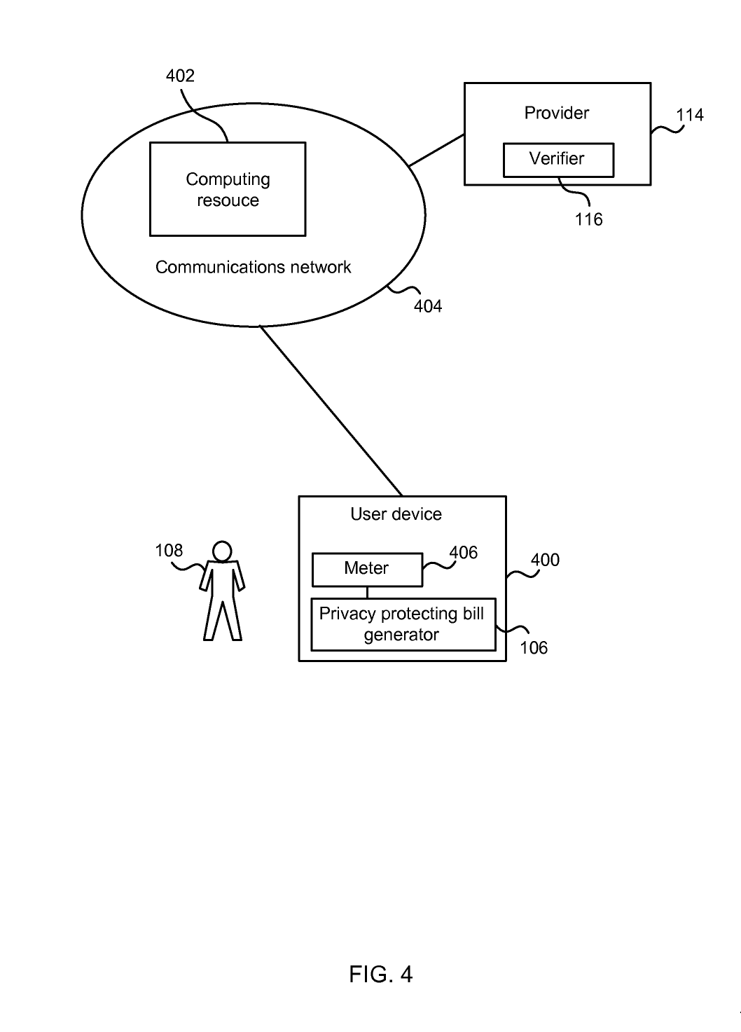

In some embodiments the meter is trusted by the user. That is the user trusts that the meter leaks no more information than meter readings. An example of this type of embodiment is now described with reference to FIG. 4 where the resource is a computing resource which may be provided using cloud computing, software as a service or in any other manner. However, any other suitable resource may be used.

FIG. 4 is a schematic diagram of a privacy preserving metering system for metering use of a computing resource 402. The computing resource may be a web service, one or more CPUs, GPUs or other processors, a distributed computing resource, one or more computing devices providing software as a service, a social networking service, a public database or other computing resource. The computing resource 402 is accessible to a user device 400 using a communications network 404 of any type. The user device 400 may be a personal computer, a mobile communications device, a laptop computer, a personal digital assistant, or any other computing device which is able to access the computing resource 402 using the communications network 404.

The user device 400 comprises a meter 406 which monitors use of the computing resource by the user device 400. The meter 406 is physically and/or functionally tamper-resistant as described above and is arranged to provide certified meter readings and/or certified commitments to meter readings using a specified commitment scheme as described above. It is not essential for the meter 406 to be integral with the user device 400 as illustrated in FIG. 4. The meter may be located at any position in communication with the user device 400 such that it is able to monitor consumption of the computing resource by a user 108 in an accurate and certifiable manner.

The user device 400 also comprises a privacy protecting bill generator 106 which is in communication with the meter 406 and is arranged to send zero knowledge proofs and privacy protecting bills to a provider 114. The privacy protecting bill generator 106 may be provided at other locations remote of the user device 400 as mentioned above.

A provider 114 controls use of the computing resource 402 and charges for use of that computing resource 402 according to one or more pricing policies. It comprises a computer implemented verifier 116 arranged to verify zero knowledge proofs provided by the bill generator.

After the meter is installed communication between the meter and the provider may be prevented in order to preserve the user's privacy. The provider is able to communicate with the bill generator to bill the user's consumption and, if permitted by the user, to learn consumption data.

In the example of FIG. 4 the meter is trusted by the user. The meter is thus able to output commitments to meter readings rather than actual meter readings themselves as discussed above. Also, the signature scheme used by the meter and provider may or may not be a re-randomizable signature scheme with efficient proofs of signature posession. Any signature scheme may be used which is unforgeable and universally verifiable. An unforgeable signature scheme is one where someone without the signature key is unable to make signatures for messages that they have not seen a valid signature on beforehand. Universally verifiable signature schemes are ones where anyone with the public verification key can verify that a signature message pair are authentic.

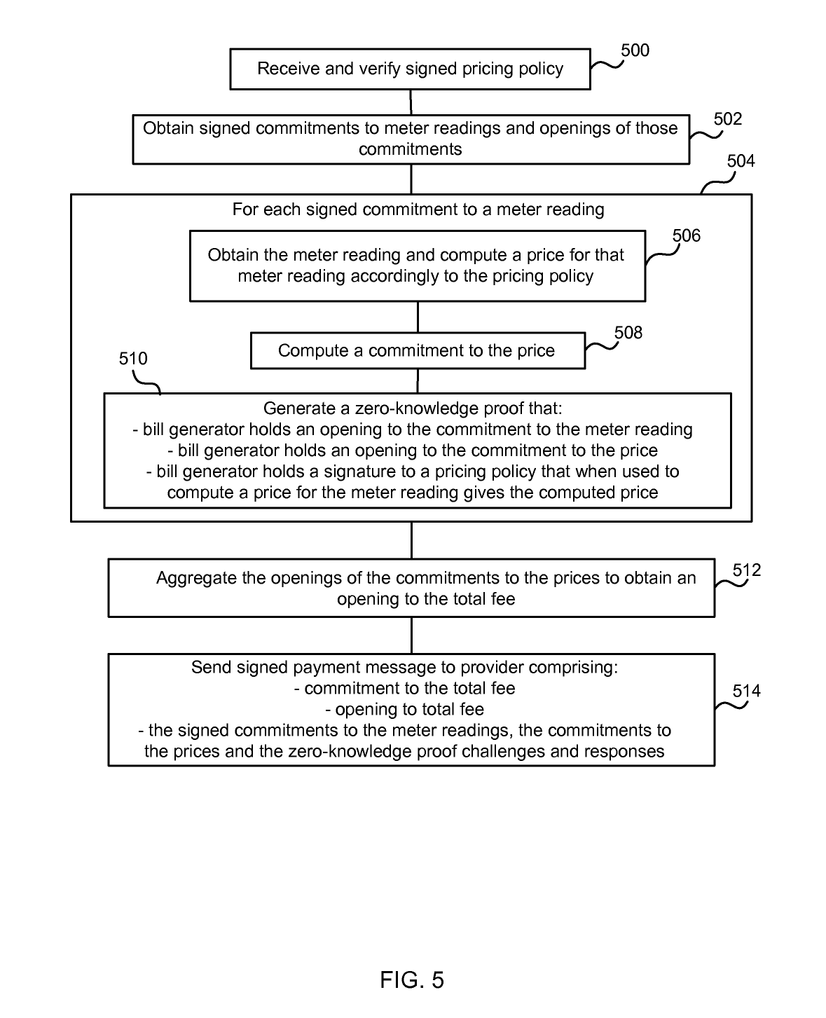

FIG. 5 is a flow diagram of a method at a bill generator such as the bill generator of FIG. 4 or any other bill generator used in a privacy preserving metering system where the meter is trusted by the user not to leak any more information than meter readings.

As described above, each of the parties (meter M, provider P and bill generator U) generates a public private key pair and registers its public key at a trusted registration entity. The provider computes parameters for an additively homomorphic commitment scheme and sends those parameters to the meter and to the bill generator. It is not essential to use an additively homomorphic commitment scheme.

At an initialization phase, the provider is able to choose a pricing policy that maps consumption values to prices. The provider signs that policy and sends it to the bill generator. The provider is able to update the pricing policy later on by sending a new signed policy to the bill generator.

With reference to FIG. 5 an example process at the bill generator is now described. The bill generator receives and verifies 500 the signature on the signed pricing policy.

The bill generator obtains 502 signed commitments to meter readings and openings of those commitments from the meter. For example, during a billing period, the meter produces tuples (d, cons, other) as described with reference to FIG. 2 above. The meter commits to cons and to other and then computes signatures sc on the commitments and on d. The meter sends the message signature pairs and the openings of the commitments to the bill generator. In this example, the meter commits separately to cons and to other. This enables U to selectively disclose either one value or the other to P in a reveal phase. However, in applications where both parameters are disclosed together or where the reveal phase is omitted, the meter may commit to both values in a single commitment in order to improve efficiency.

For each signed commitment to a meter reading 504 the bill generator obtains the meter reading and computes 506 a price for that meter reading according to the pricing policy. It computes 508 a commitment to that price. Also, it generates a zero-knowledge proof that:
the bill generator holds an opening to the commitment to the meter reading;
the bill generator holds an opening to the commitment to the price;
the bill generator holds a signature to a pricing policy that when used to compute a price for the meter reading gives the computed price.

As described above the process of generating the zero-knowledge proof may comprise generating challenges and responses.

The zero-knowledge proof comprises proofs of possession of a signature and proofs of possession of openings to commitments. This ensures that the proof does not disclose any details to the provider which could be used to find the consumption values. In both cases the zero-knowledge proof comprises a proof of possession of a signature on information that maps consumption values from the meter to prices.

Because the commitment scheme being used is additively homomorphic the bill generator is able to aggregate 512 the openings of the commitments to the prices to obtain an opening to the total fee. This simplifies computation at the bill generator. In the case that other non-homomorphic commitments schemes are used an opening to the total fee is computed in any other suitable manner. For example, the bill generator may build a commitment to the total cost and prove in zero knowledge that this is a commitment to the sum of the partial costs.

The bill generator signs and sends 514 a payment message to the provider. The payment message comprises a commitment to the total fee, an opening to the total fee, the signed commitments to the meter readings, the commitments to the prices and the zero-knowledge proof challenges and responses.

In this example, the bill generator computes, for each 504 signed commitment to a meter reading, a commitment to the price to be paid and a proof that this price is correct. To prove that the total fee is the sum of all the committed prices, the bill generator provides P with the sum of the openings of all the commitments. Computing a commitment and a proof for each tuple enables the bill generator to start the computation of the bill from the beginning of the billing period, when the total fee is unknown.

In applications where the computation of the payment message may be delayed until the tuples are known by the bill generator it is possible to avoid the computation of the commitments to prices and of one proof of knowledge per tuple. Instead it is possible to compute one zero knowledge proof of knowledge per bill message. This proof shows that the sum of the prices to be paid for each tuple equals the total fee.

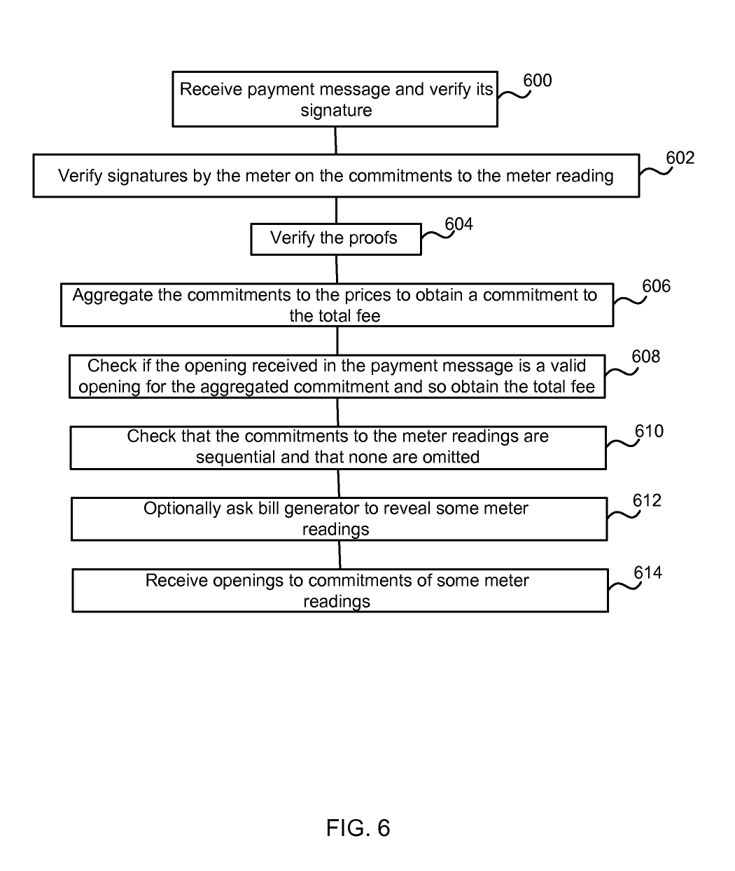

With reference to FIG. 6 an example method at a provider is now given for use in conjunction with the example method of FIG. 5. The provider receives 600 the payment message from the bill generator and verifies the signature in order to be sure that the message is in fact received from the bill generator. The provider also verifies 602 the signatures by the meter on the commitments to the meter readings. In this way the provider is sure that the meter readings did in fact originate from the meter.

The verifier at the provider verifies 604 the zero knowledge proofs. For example, this comprises computing commitments given the challenges and responses received from the bill generator. The verifier calculates anew the challenge and checks if it equals the challenge given by the bill generator.

The verifier aggregates 606 the commitments to the prices to obtain a commitment to the total fee. It checks 608 is the opening receive in the payment message is a valid opening for the aggregated commitment and so obtains the total fee. The verifier also checks 610 that the commitments to the meter readings are sequential and that none are omitted. In some cases the provider may ask 612 the bill generator to reveal some specific meter readings. This is an optional step. In response to such a request the provider may receive 614 openings to commitments of the specified meter readings, if authorization is given by the user to disclose that information. In this situation, the meter readings cannot be forged and the provider is able to prove they are correct or incorrect to a third party.

A detailed example of a protocol which implements the methods of FIGS. 5 and 6 is now given.

In this example, a signature scheme is used which consists of the algorithms (Keygen; Sign;Verify). Keygen(l^{k}) outputs a key pair (sk, pk). Sign(sk, m) outputs a signature s on message m. Verify(pk, s, m) outputs accept if s is a valid signature on m and reject otherwise. This definition can be extended to support multi-block messages m={m₁, . . . , mₙ}. Existential unforgeability is provided whereby a p.p.t. adversary is unable to output a message-signature pair (s, m) unless that adversary has previously obtained a signature on m.

In this example a non-interactive commitment scheme is used which consists of the algorithms ComSetup, Commit and Open. ComSetup(l^{k}) generates the parameters of the commitment scheme par_{c}. Commit(par_{c}, x) outputs a commitment cₓ to x and auxiliary information openₓ. A commitment is opened by revealing (x, openₓ) and checking whether Open(par_{c}, cₓ, c, openₓ) outputs accept. The commitment scheme has a hiding property and a binding property. Informally speaking, the hiding property ensures that a commitment cₓ to x does not reveal any information about x, whereas the binding property ensures that cₓ may not be opened to another value x′. A commitment scheme is said to be additively homomorphic if, given two commitments cₓ_{₁} and cₓ_{₂} with openings (x₁, openₓ_{₁}) and (x₂, openₓ_{₂}) respectively, there exists an operation such that, if c=cₓ_{₁} \textcircled{×} cₓ_{₂}, then Open(par_{c}, c, x₁+x₂openₓ_{₁}+openₓ_{₂}) outputs accept. Additionally, the commitment scheme may also provide an operation between a commitment cₓ_{₁} and a value x₂ such that, if c=cₓ_{₁} x₂, then Open(par_{c}, c, x₁×x₂, openₓ_{₁}, ×x₂) outputs accept.

In this example a trapdoor commitment scheme is used, in which algorithm ComSetup(l^{k}) generates par_{c} and a trapdoor td. Given a commitment c with opening (x₁, openₓ_{₁}) and a value x₂, the trapdoor td allows finding openₓ_{₂} such that algorithm Open(par_{c}, c, x₂, openₓ_{₂}) outputs accept.

In this example, a zero-knowledge proof of knowledge is a two-party protocol between a prover and a verifier. The prover proves to the verifier knowledge of some secret input (witness) that fulfills some statement without disclosing this input to the verifier. The protocol fulfills two properties. First, it is a proof of knowledge, i.e., a prover without knowledge of the secret input convinces a verifier with negligible probability. More technically, there exists a knowledge extractor that extracts a secret input from a successful prover with all but negligible probability. Second, it is zero-knowledge, i.e., the verifier may learn nothing but the truth of the statement. More technically, for possible verifiers there exists a simulator that, without knowledge of the secret input, yields a distribution that is indistinguishable from the interaction with a real prover. Witness indistinguishability is a weaker property that requires that the proof does not reveal which witness (among all possible witnesses) was used by the prover.

In the example, the bill generator may generate the zero knowledge proofs using any one or more of the following: proof of knowledge of a discrete logarithm; proof of knowledge of the equality of some element in different representations; proof with interval checks, range proof and proof of the disjunction or conjunction of any two of the previous. These results are often given in the form of Σ protocols but they may be turned into non-interactive zero-knowledge arguments in the random oracle model via the Fiat-Shamir heuristic. When referring to the proofs above, this document follows the notation introduced by Camenisch and Stadler for various proofs of knowledge of discrete logarithms and proofs of the validity of statements about discrete logarithms.

NIPK{(α, β, δ):y=g₀^{α}g₁^{β} [symbol] \tilde{y}=g₀^{α}g₁^{δ} [symbol] A≦α≦B} denotes “zero—knowledge Proof of Knowledge of integers α, β, and δ such that y=g₀^{α}g₁^{β}, \tilde{y}=g₀^{α}g₁^{δ} and A≦α≦B holds” where y, g₀, g₁, \tilde{y}, g₀, g₁ are elements of some groups y, g₀, g₁, \tilde{y}, g₀, g₁ that have the same order. (Note that some elements in the representation of y and \tilde{y} are equal). The convention is that letters in the parenthesis, in this example, α, β and δ, denote quantities whose knowledge is being proven, while other values are known to the verifier. In this document a non-interactive proof of signature possession is denoted as NIPK{(x, sₓ): Verify(pk, x, sₓ)=accept}.

In this example, the signature schemes used by M, U and P are denoted as: (Mkeygen;Msign;Mverify), (Ukeygen;Usign;Uverify) and (Pkeygen;Psign;Pverify). H stands for a collision-resistant hash function. In a setup phase, M runs Mkeygen(l^{k}) to obtain a key pair (sk_{M}, pk_{M}), U runs Ukeygen(l^{k}) to get a key pair (sk_{U}, pk_{U}) and P runs Pkeygen(l^{k}) to get a key pair (sk_{P}, pk_{P}). Each party registers its public key with a trusted registration entity and retrieves public keys from other parties by querying the trusted registration entity. P runs ComSetup (l^{k}) to get par_{c} and a trapdoor td, computes a proof π=NIPK{(td):(par_{c}, td)←ComSetup(l^{k})} and sends (par_{c}, π) to U and (par_{c}) to M. U verifies π.

An example protocol for privacy providing metering comprises the following phases, initialization, consumption, payment and reveal. These phases are now described in more detail.

Initialization.

When P is activated with (policy, [symbol] ), P runs SignPolicy(skₚ, [symbol] ) to get a signed policy [symbol] ₛ. P sends [symbol] ₛ to U. U runs VerifyPolicy(pkₚ, [symbol] ₛ) to get a bit b. If b=0, U rejects the policy. Otherwise U stores [symbol] ₛ.

Consumption.

When M is activated with (consume, cons, other), M increments a counter d_{M} (initialized at zero) and runs SignConsumption(sk_{M}, par_{c}, cons, other, d_{M}) to obtain a signed consumption SC. M sends (SC) to U. U increments a counter d_{U} and runs VerifyConsumption(pk_{M}, par_{c}, SC, dᵤ) to obtain a bit b. If b=0, U rejects SC and sends P a message indicating malfunctioning meter. Otherwise U appends SC to a table T that stores all the consumptions.

Payment.

When P is activated with (payment), P sends (payment) to U. Let N be the number of (consume, . . . ) messages received by U since the previous message (payment) was received. U runs Pay(sk_{U}, par_{c}, [symbol] ₛ, T[d_{U}−N:d_{U}]) to obtain a payment message Q and sends (Q) to P. P runs VerifyPayment(pk_{M}, pk_{U}, pk_{P}, par_{c}, Q, d_{P}) to obtain (b, d′_{P}). If b=0, P rejects the payment, and otherwise accepts it and sets d_{P}=d′_{P}.

Reveal.

When P is activated with (reveal, i), P checks that i ∈ [0, d_{P}] and sends (i) to U. U runs Reveal(sk_{U}, T, i) to get an opening message R and sends (R) to P. P picks the payment message Q that contains i and runs VerifyReveal(pk_{U}, par_{c}, Q, R, i) to get a bit b. If b=0, P sends (reject, Q, R) to U, and otherwise it sends (accept) to U. Examples of the functions used in the example protocol phases are now specified.

SignPolicy (sk_{P}, [symbol] ).

For each tuple (cons, other, price) ∈ [symbol] , compute sp=Psign(sk_{P} [symbol] cons, other, price [symbol] ). (The way the tuples (cons, other, price) are signed depends on the particular policy IC [symbol] to be signed as described in more detail below). Let [symbol] ₛ=(consᵢ, otherᵢ, priceᵢ, spᵢ)ᵢ₌₁ⁿ be the set of message-signature tuples.

Output [symbol] ₛ.

VerifyPolicy (pk_{P}, [symbol] ₛ).

For i=1 to n, parse [symbol] ₛ as (consᵢ, otherᵢ, priceᵢ, spᵢ)ᵢ₌₁ⁿ, and, for i=1 to n, run Pverify(pk_{P}, spᵢ, [symbol] consᵢ, otherᵢ, priceᵢ [symbol] ). If any of the outputs is reject, output b=0, and otherwise output b=1.

SignConsumption (sk_{M}, par_{c}, cons, other, d_{M}) .

Execute both (c_{cons}, open_{cons})=Commit(par_{c}, cons) and (Cₒₜₕₑᵣ, openₒₜₕₑᵣ)=Commit(par_{c}, other). Run sc=Msign (sk_{M}, [symbol] d_{M}, c_{cons}, cₒₜₕₑᵣ [symbol] ) and output SC=(d_{M}, cons, open_{cons}, c_{cons}, other, openₒₜₕₑᵣ, cₒₜₕₑᵣ, sc).

VerifyConsumption (pk_{M}, par_{c}, SC, d_{U}).

Parse message SC as (d_{M}, cons, open_{cons}, c_{cons}, other, openₒₜₕₑᵣ, cₒₜₕₑᵣ, sc). Compute Open(par_{c}, c_{cons}, cons, open_{cons}) and Open(par_{c}, cₒₜₕₑᵣ, other, openₒₜₕₑᵣ) and output b=0 if any of them outputs reject. Run Mverify(pk_{M}, sc, [symbol] d_{U}, c_{cons}, cₒₜₕₑᵣ [symbol] ) and output b=0 if the output is reject. Otherwise output b=1.

Pay(sk_{U}, par_{c}, [symbol] ₛ, T).

For each entry (d_{M}, cons, open_{cons}, c_{cons}, other, openₒₜₕₑᵣ, cₒₜₕₑᵣ, sc) ∈ T, calculate price= [symbol] (cons, other), run(c_{price, open}_{price})=Commit(par_{c}, price) and calculate a non-interactive witness-indistinguishable proof π:¹

NIPK{(price, open_{price}, cons, open_{cons}, other, openₒₜₕₑᵣ, sp): (c_{cons}, open_{cons})=Commit(par_{c}, cons) [symbol] (cₒₜₕₑᵣ, openₒₜₕₑᵣ)=Commit(par_{c},other) [symbol] (c_{price}, open_{price})=Commit(par_{c}, price) [symbol] Pverify(pk_{P}, sp, [symbol] cons, other, price [symbol] )=accept}

Let N be the number of entries in T. Compute the total fee fee=Σᵢ₌₁^{N} priceᵢ and add all the openings open_{fee}=Σᵢ₌₁^{N} open_{price}_{ᵢ} to get an opening to the commitment to the fee. Set a payment message p=(fee, open_{fee}, {scᵢ, d_{M}, c_{cons}_{ᵢ}, cₒₜₕₑᵣ_{ᵢ}, c_{price}_{ᵢ}, πᵢ}ᵢ₌₁^{N}).

Compute a signature² sp=Usign (sk_{U}, p) and set a payment message Q=(p, sₚ).

VerifyPayment (pk_{M}, pk_{U}, pk_{P}, par_{c}, Q, dp).

Parse Q as (p, sₚ) and run Uverify(pk_{U}, sₚ, p). Output b=0 if it rejects.

Otherwise parse p as (fee, open_{fee}, {scᵢ, dᵢ, c_{cons}_{ᵢ}, cₒₜₕₑᵣ_{ᵢ}, c_{price}_{ᵢ}, πᵢ}ᵢ₌₁^{N}) and, for i=1 to N, increment dₚ, run Mverify (pk_{M}, scᵢ, [symbol] dₚ, c_{cons}, cₒₜₕₑᵣ, [symbol] ) and verify πᵢ. Output b=0 if any of the signatures or the proofs is not correct. Add the commitments to the prices c′_{fee}=\textcircled{×}ᵢ₌₁^{N}c_{price}_{ᵢ} and execute Open(par_{c}, c′_{fee}, fee, open_{fee}). If the output is accept, set b=1 and otherwise b=0. Output (b, dₚ).

Reveal (sk_{U}, T, i).

Pick the tuple r=(i, cons, open_{cons}, other, openₒₜₕₑᵣ) in the entry (i, . . . ) ∈ T, sign sᵣ=Usign (sk_{U}, r) and output R=(r, sᵣ) .

VerifyReveal (pk_{U}, par_{c}, Q, R, j).

Parse Q as (p, sₚ) and p as (fee, open_{fee}, {scᵢ, dᵢ, c_{cons}_{ᵢ}, cₒₜₕₑᵣ_{ᵢ}, c_{price}_{ᵢ}, πᵢ}ᵢ₌₁^{N}). Pick the tuple (scᵢ, dᵢ, c_{cons}_{ᵢ}, cₒₜₕₑᵣ_{ᵢ}, c_{price}_{ᵢ}, πᵢ) such that dᵢ=j. Parse R as (r, sᵣ) and r as (i, cons, open_{cons}, other, openₒₜₕₑᵣ). Run algorithms Open(par_{c}, c_{cons}, cons, open_{cons}) and Open(par_{c}, cₒₜₕₑᵣ_{ᵢ}, other, openₒₜₕₑᵣ). If both algorithms output accept, output b=1 and otherwise b=0.

As explained above, the provider is able to use different forms of pricing policy. For example, a discrete pricing policy, a linear pricing policy, a cumulative pricing policy, and a pricing policy defined by one or more polynomial functions. The way the tuples (cons; other; price) are signed depends on the particular form of policy to be signed and this in turn affects what the zero-knowledge proof needs to show. Examples of different types of pricing policy are now given together with examples of methods of signing the tuples for each of those types of pricing policy and examples of how to generate a zero-knowledge proof appropriate to each type of pricing policy. In general, more complex pricing policies require more complex zero-knowledge proofs since there is more to prove. Careful design of the data structures used for the pricing policy and the signed tuples is therefore important since it affects the computational complexity and efficiency at the bill generator and verifier. In the example discussed above with reference to FIGS. 2 and 3 a discrete pricing policy is used. However, that is not essential. The methods of FIGS. 2 and 3 may be arrange to operate with other types of pricing policy by using the data structures and methods of signing the tuples and generating the zero-knowledge proofs now described.

Discrete Pricing Policy.

A discrete pricing policy considers a discrete domain described by n tuples (cons, other). Each tuple is mapped to a price price. To sign the policy, for i=1 to n, P runs spᵢ=Psign(skₚ, [symbol] consᵢ, otherᵢ, priceᵢ [symbol] ), and sets [symbol] ₛ=(consᵢ, otherᵢ, priceᵢ, spᵢ)ᵢ₌₁^{N}.

To compute the proof π, U uses the commitments to the consumption c_{cons} and to other parameters cₒₜₕₑᵣ included in sc, and commits to the price (c_{price}, open_{price},)=Commit(par_{c}, price) specified in the policy for (cons, other). Then U proves possession of a signature sp ∈ [symbol] ₛ on (cons, other, price) and equality between the signed values and the values committed to in (c_{cons}, cₒₜₕₑᵣ, c_{price}). The non interactive zero knowledge proof (NIPK) is then:

NIPK (price, open_{price}, cons, open_{cons}, other, openₒₜₕₑᵣ, sp): (c_{cons}, open_{cons})=Commit(par_{c} ,cons) [symbol] (cₒₜₕₑᵣ, openₒₜₕₑᵣ)=Commit(par_{c}, other) [symbol] (c_{price}, open_{price})=Commit(par_{c}, price) [symbol] Pverify(pk_{P}, sp, [symbol] cons, other, price [symbol] )=accept}

Linear Pricing Policy.

A discrete policy is beneficial when the set of possible consumption values is finite and small. Otherwise, signing all possible tuples (cons, other) may be inefficient. A linear policy, instead of specifying the price of each possible consumption, specifies the price per unit. For instance, if a policy says that the price per unit is 3 and the consumption is 6, the price due is 18. Therefore, since a linear policy specifies the price per unit of consumption, it is given by [symbol] : other→price. The parameter other denotes any variable that influences the price per unit, e.g., the time interval in which the consumption takes place.

To sign this policy, for i=1 to n, P runs spᵢ=Psign(sk_{P}, [symbol] otherᵢ, priceᵢ [symbol] ), and sets [symbol] ₛ=(otherᵢ, priceᵢ, spᵢ)ᵢ₌₁ⁿ. To compute a proof π, U uses the commitments to the consumption c_{cons} and to other parameters cₒₜₕₑᵣ included in sc, and commits to the total price priceᵢ ((c_{price}_{ᵢ}, open_{price}_{ᵢ})=Commit(par_{c}, priceᵢ)). (The total price equals priceᵢ=price·cons, where price= [symbol] (other).)

Then U computes a proof of possession of a signature sp Å [symbol] ₛ on (other, price), a proof of equality between other and the values committed to in cₒₜₕₑᵣ and a proof that priceᵢ committed to in c_{price} equals price·cons. The non interactive proof of knowledge is then:

NIPK{(price,open_{price}, cons, open_{cons}, other, openₒₜₕₑᵣ, sp): (c_{cons}, open_{cons})=Commit(par_{c}, cons) [symbol] (cₒₜₕₑᵣ, openₒₜₕₑᵣ)=Commit(par_{c}, other) [symbol] (c_{price}, open_{price})=Commit(par_{c}, price) [symbol] Pverify(pk_{P}, sp, [symbol] cons, other, price [symbol] )=accept}

Interval Pricing Policy.

In an interval policy, the consumption values domain is divided into intervals and each interval is mapped to a price. For instance, if the policy says that all the consumptions between 4 and 7 must pay price 3 and the consumption is 5, the price due is 3. Therefore, an interval policy is given by [symbol] :(consₘᵢₙ,consₘₐₓ,other)→price, where it is required that intervals defined by [consₘᵢₙ, consₘₐₓ] be disjoint.

To sign this policy, for i=1 to n, P runs spᵢ=Psign(sk_{P}, [symbol] consₘᵢₙ_{ᵢ}, consₘₐₓ_{ᵢ}, otherᵢ, priceᵢ [symbol] ), and sets [symbol] ₛ=(consₘᵢₙ_{ᵢ}, consₘₐₓ_{ᵢ}, otherᵢ, priceᵢ, spᵢ)ᵢ₌₁ⁿ. (Note that if π is a monotonic function, then it is enough to sign consₘₐₓ (when the function is increasing) or consₘᵢₙ (when the function is decreasing)). To compute a proof π, U uses the commitments to the consumption c_{cons} and to other parameters cₒₜₕₑᵣ included in sc, and commits to the price (c_{price}, open_{price})=Commit(par_{c}, price) specified in the policy for (consₘᵢₙ, consₘₐₓ, other) such that cons ∈ [consₘᵢₙ, consₘₐₓ]. Then U computes a proof of possession of a signature sp ∈ [symbol] ₛ on (consₘᵢₙ, consₘₐₓ, other, price), a proof of equality between (other, price) and the values committed to in (cₒₜₕₑᵣ, c_{price}), and a proof that cons ∈ [consₘᵢₙ, consₘₐₓ]. If the policy is monotonically increasing, it suffices to prove that ∈ [0, consₘₐₓ], while if it is monotonically decreasing, it suffices to prove that cons ∈ [consₘᵢₙ, ∞]. The non interactive proof of knowledge is then:

NIPK {(price, open_{price}, cons, open_{cons}, other, openₒₜₕₑᵣ, consₘᵢₙ, consₘₐₓ, sp): (c_{cons}, open_{cons})=Commit(par_{c}, cons) [symbol] (cₒₜₕₑᵣ, openₒₜₕₑᵣ)=Commit(par_{c},other) [symbol] (c_{price}, open_{price})=Commit(par_{c}, price) [symbol] Pverify(pkₚ, sp, [symbol] cons, other, price [symbol] )=accept [symbol] cons ∈ [consₘᵢₙ, consₘₐₓ[}

Cumulative Pricing Policy.

As in the case of the interval policy, the consumption values domain is divided into intervals and each interval is mapped to a price. However, in this case this price is a price per unit of consumption. The price due is the definite integral of the policy [symbol] over the interval [0, cons]. For instance, let [symbol] be a policy as follows: [0,3]→2,(3,7]÷5,(7, ∞), (the parameter other is left unused) and let the consumption be 9. The price due is 3×2+4×5+2×8=42. Therefore, a cumulative policy is given by [symbol] : (consₘᵢₙ, consₘₐₓ, F, other)→price, where it is required that intervals defined by [consₘᵢₙ, consₘₐₓ] be disjoint. F is the definite integral of [symbol] over the [0,consₘᵢₙ]. To sign this policy, for i=1 to n, P runs spᵢ=Psign(skₚ, [symbol] consₘᵢₙ_{ᵢ}, consₘₐₓ_{ᵢ}, F, otherᵢ, priceᵢ [symbol] ), and sets [symbol] ₛ=(consₘᵢₙ_{ᵢ}, consₘₐₓ_{ᵢ}, Fᵢ, otherᵢ, priceᵢ, spᵢ)ᵢ₌₁ⁿ. In the previous example, the tuples to be signed are (0,3,0,⊥,2),(3,7,6,⊥,5) and (7, max, 26, ⊥, 8) (max represents the maximum consumption). To compute a proof π, U uses the commitments to the consumption c_{cons} and to other parameters cₒₜₕₑᵣ included in sc, and commits to the price priceₜ((c_{price}_{ₜ}, open_{price}_{ₜ})=Commit(par_{c}, priceᵢ)) to be paid, which equals priceₜ=(cons−consₘᵢₙ)×price+F). Then U computes a proof of possession of a signature sp ∈ [symbol] ₛ on (consₘᵢₙ, consₘₐₓ, F, other, price), a proof of equality between (other) and the value committed to in cₒₜₕₑᵣ, a proof that cons ∈ [consₘᵢₙ, consₘₐₓ] and a proof that priceᵢ=(cons−consₘᵢₙ)×price+F. The non interactive proof of knowledge is then:

NIPK {(priceᵢ, open_{price}_{ᵢ}, cons, open_{cons}, other, openₒₜₕₑᵣ, price, consₘᵢₙ, consₘₐₓ, F, sp): (c_{cons}, open_{cons})=Commit(par_{c},cons) [symbol] (cₒₜₕₑᵣ, openₒₜₕₑᵣ)=Commit(par_{c},other) [symbol] (c_{price}_{ₜ}, open_{price}_{ₜ})=Commit(par_{c}, priceₜ) [symbol] Pverify(pkₚ,sp, [symbol] consₘᵢₙ, consₘₐₓ, F, other, price [symbol] )=accept [symbol] cons ∈ [consₘᵢₙ, consₘₐₓ] [symbol] priceₜ=(cons−consₘᵢₙ)×price+F}

Other Pricing Polices.

Another possible policy [symbol] is that defined by a polynomial function Σᵢ₌₀^{N} aᵢxⁱ over a commutative ring R, which in an implementation is given by the integers modulo a composite. This gives the benefit that any pricing policy can be approximated to an arbitrary precision. The price due is the evaluation of [symbol] on input the consumption x=cons.

Let n be the number of polynomials that define the policy (e.g., each of them associated with a different parameter other). To sign this policy, for i=1 to n, P runs spᵢ=Psign(skₚ, [symbol] a_{Ni}, . . . ,a₀ᵢ, otherᵢ [symbol] ), and sets [symbol] ₛ=(a_{Ni}, . . . ,a₀ᵢ, other, spᵢ)ᵢ₋₁ⁿ. To compute a proof π, U uses the commitments to the consumption c_{cons} and to other parameters cₒₜₕₑᵣ included in sc, and commits to the price priceᵢ((c_{price}_{ₜ}, open_{price}_{ₜ})=Commit (par_{c}, priceₜ)) to be paid, which equals priceₜ=Σᵢ₌₀^{N}aᵢconsⁱ. Then U computes a proof of possession of a signature sp ∈ [symbol] ₛ on (a_{N}, . . . , a₀, other), a proof of equality between (other) and the value committed to in cₒₜₕₑᵣ, and a proof that priceₜ=Σᵢ₌₀^{N}aᵢconsⁱ. The non interactive proof of knowledge is then:

$$NIPK \{ ( {price}_{t} , {open}_{{price}_{t}} , cons , {open}_{cons} , other , {open}_{other} , sp ) : ( {c}_{cons} , {open}_{cons} ) = Commit ( {par}_{c} , cons ) ⋀ ( {c}_{other} , {open}_{other} ) = Commit ( {par}_{c} , other ) ⋀ ( {c}_{{price}_{t}} , {open}_{{price}_{t}} ) = Commit ( {par}_{c} , {price}_{t} ) ⋀ Pverify ( {pk}_{P} , sp , 〈 {a}_{N} , … , {a}_{0} , other 〉 ) = accept ⋀ {price}_{t} = {\sum }_{i = 0}^{N} {a}_{i} {cons}^{i} \}$$

Particular examples of the commitment scheme, the signature schemes and the non-interactive proofs of knowledge which may be used are now given. These are examples only.

An integer commitment scheme may be used as now described.

For the example integer commitment scheme let lₙ be the bit-length of an RSA modulus n and lₙ be the bit-length of the security parameter. Example values are lₙ=2048 and lᵣ=80. The scheme is then:

CompSetup(l^{k}). Given an RSA modulus, pick a random generator h ∈ QRₙ. Pick random α₁, . . . , αₖ←{0,1}^{l}^{ₙ}^{+l}^{ᵣ} and, for i=1 to k, compute gᵢ=h^{α}^{ᵢ}. Output commitment parameters par_{c}=(gᵢ, . . . , gₖ, h, n) and trapdoor td=(α₁, . . . , αₖ).

Commit (par_{c}, [symbol] m₁, . . . , mₖ [symbol] ). On input integers (m₁, . . . , mₖ) of length lₘ, choose a random open ∈ {0,1}^{l}^{ₙ}^{+l}^{ᵣ}, and compute C=g₁^{m}^{₁} • . . . • gₖ^{m}^{ₖ}h^{open} (mod n). Output the commitment c and the opening open.

Open (par_{c}, c, [symbol] m′₁, . . . , m′ₖ [symbol] , open′). On inputs integers (m′₁, . . . , m′ₖ) and open′, compute c′=g₁^{m′}^{₁} • . . . • gₖ^{m′}^{ₖ}h^{open′} (mod n) and check whether c=c′.

Signature Schemes.

The signature schemes of M and U may be instantiated with any existentially unforgeable signature scheme. For P's signature scheme, a Camenisch and Lysyanskaya signature scheme may be used in some examples as now described. This is beneficial in the embodiments described herein because it is partially re-randomizable and has efficient proofs of signature possession.

Keygen (l^{k}). On input l^{k}, generate two primes p, q of length k such that p=2p′+1 and q=2q′+1, where p′ and q′ are also primes. The RSA modulus of length lₙ is defined as n=pq. Output secret key sk=(p, q). Choose uniformly at random S←QRₙ, and R₁, . . . , Rₖ, Z← [symbol] S [symbol] . Compute a non-interactive zero-knowledge proof

$$π = N I P K \{ ( {x}_{Z} , {x}_{{R}_{1}} , … , {x}_{{R}_{l}} ) : Z = {S}^{{x}_{z}} {R}_{1} = {S}^{{x}_{{R}_{1}}} … {R}_{l} = {S}^{{x}_{{R}_{l}}} \} .$$

Output public key pk=(n, R₁, . . . , Rₖ, S, Z, π).

Sign (sk, [symbol] m₁, . . . , mₖ [symbol] ). On input messages (m₁, . . . , mₖ) of length lₘ, choose a random prime number e of length lₑ>lₘ+2, and a random number v of length lᵥ=lₙ+lₘ+lᵣ. Compute the value A such that Z=A^{e}R₁^{m}^{₁} • . . . • Rₖ^{m}^{ₖ}S^{v} (mod n). Output the signature s=(e, A, v).

Verify (pk, s, [symbol] m₁, . . . , mₖ [symbol] ). On inputs messages (m₁, . . . , mₖ) and signature s=(e, A, v), check that Z≡A^{e}R₁^{m}^{₁}• . . . • Rₖ^{m}^{ₖ}S^{v} (mod n), that mᵢ ∈ ±{0,1}lₘ, and that 2^{l}^{ₑ}≦e≦2^{l}^{ₑ}¹. Example values are lₙ=2048, lᵣ=80, lₘ=256, lₑ=597, lᵥ=2724 ([29]).

Examples of basic buildings blocks that compose the non-interactive zero-knowledge proofs utilized in the embodiments are now given. Such non-interactive zero-knowledge proofs consist of the conjunction of some of these building blocks. The basic building blocks may be a non-interactive zero-knowledge proof of possession of a Camenisch-Lysyanskaya signature, a proof that a committed value is the product of two committed values and a proof that a committed value lies in an interval.

To prove possession of a Camenisch-Lysyanskaya signature, an example method is:

Given a signature s=(e, A, v) on messages (m₁, . . . , mₖ), randomize the signature s by picking random r←{0,1}^{l}^{ₙ}^{+l}^{_{Ø}} and computing (e, A′=AS^{-r} (mod n), v′=v+er). Additionally set e′=e−2^{l}^{ₑ}⁻¹. Send A′ to the verifier along with the following non-interactive zero-knowledge proof:

NIPK {(e, v, m₁, . . . , mₖ): Z≡±A^{e}R₁^{m}^{₁} • . . . • Rₖ^{m}^{ₖ}S^{v} (mod n)

[symbol]

mᵢ ∈ {0,1}^{l}^{ₘ}^{+l}^{_{H}}^{+l}^{_{Ø}}⁺² [symbol] e−2^{l}^{ₑ}⁻¹ ∈ {0,1}^{l′}^{ₑ}^{+l}^{_{H}}^{+l}^{_{Ø}}⁺²}

This proof becomes a non-interactive zero-knowledge argument via the Fiat-Shamir heuristic as follows. (The other proofs in the embodiments may be computed via the Fiat-Shamir heuristic in a similar way.) Let H be a hash function modeled as a random oracle. The prover picks random values:

rₑ←{0,1}^{l′}^{ₑ}^{+l}^{_{H}}^{+l}^{_{Ø}}

r_{v′}←{0,1}^{l}^{ᵥ}^{+l}^{_{H}}^{+l}^{_{Ø}}

{rₘ_{ᵢ}}ᵢ₌₁^{k}←{0,1}^{l}^{ₘ}^{-l}^{_{H}}^{+l}^{_{Ø}}

where l_{H} is the size of the challenge, l_{Ø} controls statistical zero-knowledge and ′ₑ<lₑ−l_{H}−l_{Ø}−3 is the bit-length that determines the interval from which e is taken in order to succeed in the proof with interval checks e−2^{l}^{ₑ}⁻¹ ∈ {0,1}^{l′}^{ₑ}^{+l}^{_{H}}^{+l}^{_{Ø}}⁺². The prover computes a commitment

$${t}_{Z} = {A}^{′ {r}_{e} } {R}_{1}^{{r}_{{m}_{1}}} \cdot … \cdot {R}_{k}^{{r}_{{m}_{k}}} {S}^{{r}_{v}}$$

and a challenge ch=H (n| |A′| |R₁| | . . . | Rₖ| |S| |Z| |t_{Z}). The power computes responses:

sₑ=rₑ−ch·e′

s_{v′}=r_{v′}−ch·v′

{sₘ_{ᵢ}}ᵢ₌₁^{k}=rₘ_{ᵢ}−ch·mᵢ

and sends to the verifier

$$π = ( {A}^{′} ch , {s}_{e} , {s}_{{v}^{′}} , {\{ {s}_{{m}_{i}} \}}_{i = 1}^{k} ) .$$

The verifier computes

$${{t}_{Z}^{′} = {( Z / {A}^{′} )}^{{2}^{{l}_{e}^{′} - 1}} )}^{ch} {A}^{′ {S}_{e}} {R}_{1}^{{S}_{{m}_{1}}} \cdot … \cdot {R}_{k}^{{S}_{{m}_{k }}} {S}^{{S}_{{v}^{′}}} ,$$

verifies if ch=H(n| |A′| |R₁| | . . . | |Rₖ| |S| |Z| |t_{Z}), and runs the interval checks sₑ ∈ ±{0,1}^{l′}^{ₑ}^{+l}^{_{H}}^{+l}^{_{Ø}}⁺¹ and {sₘ_{ᵢ}}ᵢ₌₁^{k} ∈ ±{0,1}^{l}^{ₘ}^{+l}^{_{H}}^{+l}^{_{Ø}}⁺¹.

Example values for the parameters are l_{H}=256, l_{Ø}=80 and l′ₑ=120.

To prove that a message m₃ committed to in

$${c}_{{m}_{3 e}} = {g}_{1}^{{m}_{3}} {h}^{{open}_{{m}_{3}}}$$

is the
product of two messages m₁ and m₂ committed to in

$${c}_{{m}_{3}} = {g}_{1}^{{m}_{3}} {h}^{{open}_{{m}_{3}}} and {c}_{{m}_{2}} = {g}_{1}^{{m}_{2}} {h}^{{open}_{{m}_{2}}}$$

respectively, the following proof can be used:

$$NIPK \{ \begin{matrix}( \begin{matrix}{m}_{1} , {open}_{{m}_{1}} , {m}_{2} , {open}_{{m}_{2}} , \\ {m}_{3} , {open}_{{m}_{3}} , {m}_{2} \cdot {open}_{{m}_{1}}\end{matrix} ) \text{:} \\ {c}_{{m}_{1}} = {g}_{1}^{{m}_{1}} {h}^{{open}_{{m}_{1}}} ⋀ {c}_{{m}_{2}} = {g}_{1}^{{m}_{2}} {h}^{{open}_{{m}_{2}}} ⋀ \\ {c}_{{m}_{3}} = {g}_{1}^{{m}_{3}} {h}^{{open}_{{m}_{3}}} ⋀ \\ 1 = {{c}_{{m}_{1}}^{{m}_{2}} ( 1 / {g}_{1} )}^{{m}_{3}} {( 1 / h )}^{{m}_{2} \cdot {open}_{{m}_{1}}}\end{matrix} \}$$

To prove that a committed value x lies in an interval [a, b], it is shown that x−a≧0 and b−x≧0. For example, a non-interactive zero knowledge proof may be used to prove that an integer in m≧0. The proof is based on the fact that any positive integer in of the form 4m+1 can be written as a sum of three squares a²+b²+d². Therefore, to prove that m≧0, the method proves that 4m+1=a²+b²+d². Values (a, b, d) may be computed via the Rabin-Shallit algorithm. The proof is:

NIPK {(m,openₘ,a,b,d): Cₘ=g^{m}h^{open}^{ₘ} [symbol] 4m+1=a²+b²+d²}

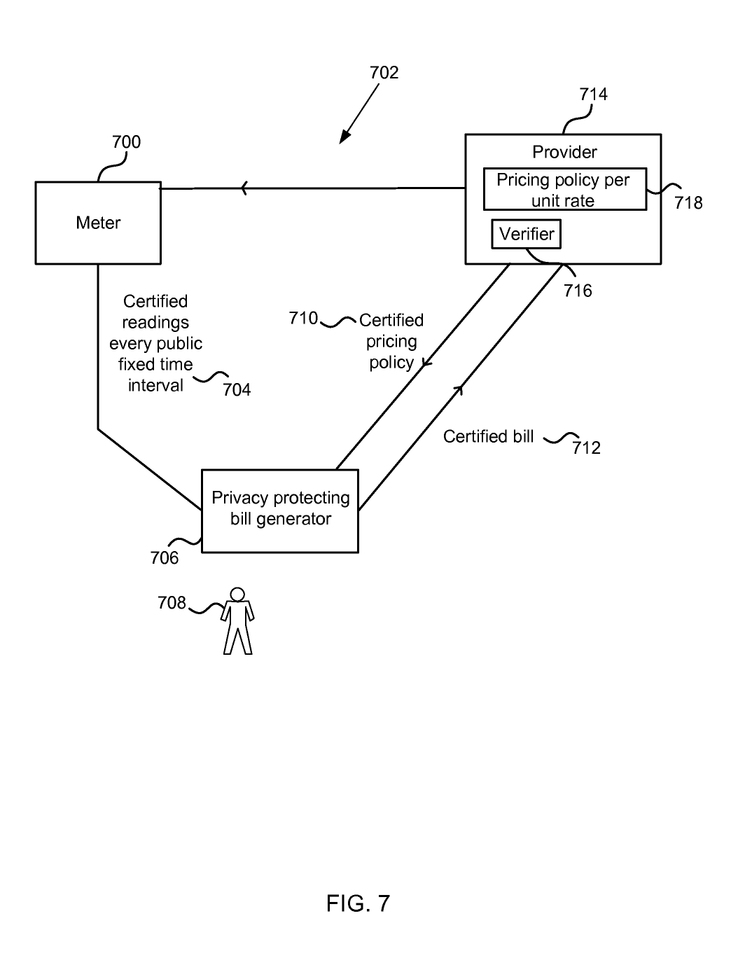

An example of a system for privacy preserving metering is now given where the pricing policy is a per unit rate pricing policy which is public domain and the meter readings are taken at specified time intervals which are public domain. This example is particular suited for utility metering where meter readings are often taken at specified time intervals, such as every half and hour, and this information as well as the pricing policy is public. In this example the meter is trusted that is, the user trusts that the meter leaks no more information than meter readings. With reference to FIG. 7 a meter 700 provides certified readings every public, fixed time interval t. These meter readings may be tuples as described for the other embodiments above. The meter is tamper-resistant and may be a smart utility meter as mentioned above. The certified meter readings are provided to a privacy protecting bill generator 706 which is an agent of a user 708 as described above. A provider 714 of a resource, such as a power or water utility to be consumed by the user 708 has a computer implemented verifier 716 and stores one or more public domain pricing policies 718 which are of a price per unit rate type (also referred to as a linear pricing policy). The provider is able to communicate with the meter 700 although that is not essential. The provider sends the certified pricing policy 710 to the bill generator 706. The bill generator uses the certified meter readings 704 and the certified pricing policy 710 to generate a bill which does not disclose the user's consumption data to the provider. The bill generator 706 also generates a proof 712 (which is this case does not need to be zero knowledge) and sends that to the provider together with the bill. The proof is verified by the verifier 716 to show that the bill is correct without disclosing the user's consumption data to the provider

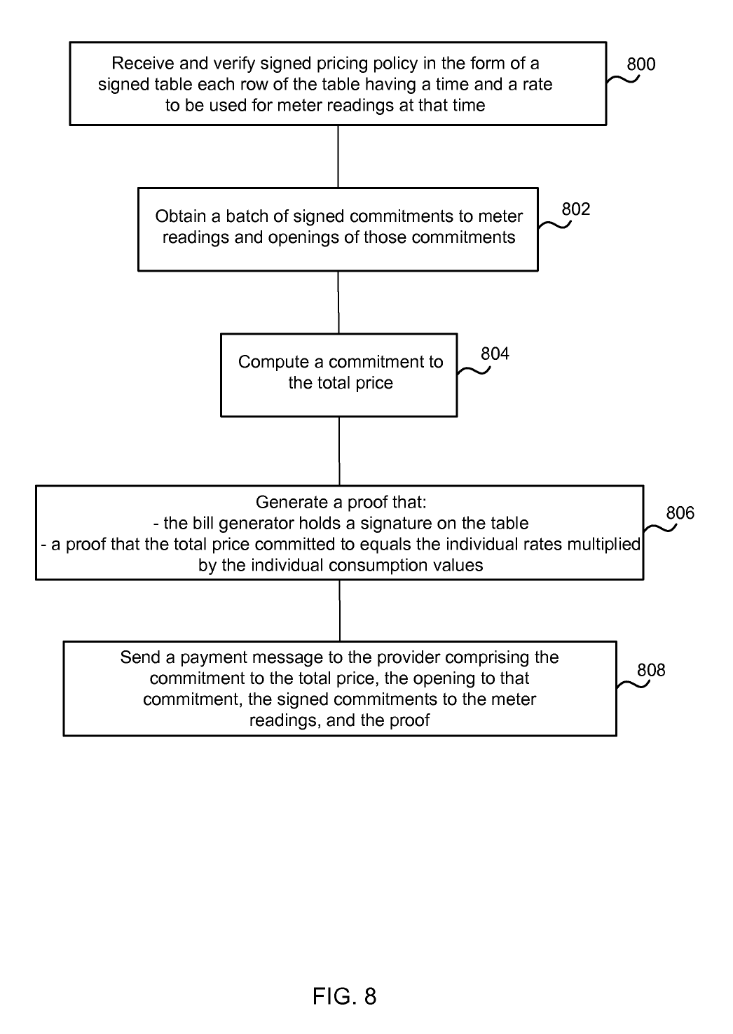

In this example, the method at the bill generator may be as follows. With reference to FIG. 8, the bill generator receives and verifies 800 a signed pricing policy in the form of a signed table, each row of the table having a time and a rate to be used for meter readings at that time. Because the whole table is signed rather than each individual table row efficiencies are achieved. The bill generator receives 802 a batch of signed commitments to meter readings and openings of those commitments in the same manner as described above with reference to FIG. 5. The bill generator computes 804 a commitment to the total price and sends 806 that commitment and its opening to the provider using a payment message. The bill generator forms a proof 806 that the bill generator holds a signature on the pricing policy table, and that the total price committed to equals the individual rates multiplied by the individual consumption values. Because the pricing policy is public domain and the meter reading intervals are public domain the proof does not need to be zero knowledge. The computation of the proof is thus simplified as compared with the situations of FIGS. 3 and 5. The bill generator sends 808 a signed payment message to the provider comprising the commitment to the total price, the opening to that commitment, the signed commitments to the meter readings and the proof.

The verifier at the provider receives the payment message and verifies its signature and verifies the proof It opens the commitment to the total price.

A detailed example is now described in which the pricing policy is public domain and where the pricing policy comprises linear formulas of the form price=a₁·cons+a₀. This example is an efficient construction that avoids the use of non-interactive zero-knowledge proofs. This example uses a commitment scheme provided with two operations \textcircled{×} and e (described here) that allow to compute a commitment to the price given a commitment to the consumption value.

In this situation an example protocol for privacy providing metering comprises the following phases:

Initialization

When P is activated with (policy, [symbol] ), where [symbol] is a linear policy, P publishes a unique policy identifier idᵢ and sends (idᵢ, [symbol] ) to U.

Consumption

This phase may be as described earlier in this document.

Payment

When P is activated with (payment), P sends (payment) to U. Let N be the number of (consume, . . . ) messages received by U since the previous message (payment) was received. U runs EffPay(sk_{U}, par_{c}, id [symbol] , [symbol] , T[d_{U}−N:d_{U}]) to obtain a payment message Q and sends (Q) to P. P runs EffVerifyPayment(pk_{M}, pk_{U}, parₑ, idᵣ, Q, d_{P}) to obtain (b, d′ₚ). If b=0, P rejects the payment, and otherwise accepts it and sets d_{P}=d′_{P}.

Reveal

This phase may be as described earlier in this document.

Examples of the functions used in the example protocol phases are now specified:

EffPay(sk_{U}, par_{c}, i [symbol] , [symbol] , T). For each table entry (d_{M}, cons, open_{cons}, c_{cons}, other, openₒₜₕₑᵣ, cₒₜₕₑᵣ, sc) ∈ T, calculate price=a₁·cons+a₀ and open_{price}=open_{cons}·a. Let N be the number of entries in T. Compute the total fee fee=Σᵢ₌₁^{N} priceᵢ and add all the openings open_{fee}=Σᵢ₌₁^{N}open_{price}_{ᵢ} to get an opening to the commitment to the fee. Set a payment message p=(i [symbol] , fee, open_{fee}, {scᵢ, d_{M}_{ᵢ}, c_{cons}ᵢ, cₒₜₕₑᵣ_{ᵢ}, πᵢ}ᵢ₌₁^{N}). Compute a signature sₚ=Usign(sk_{U}, p) and set a payment message Q=(p,sₚ). If p does not belong to the message space of the signature scheme, sign H(p), where H is a collision resistant hash function whose range is the message space of the signature scheme. EffVerifyPayment(pk_{M}, pk_{U}, par_{c}, i [symbol] , Q, d_{P}). Parse Q as (p, sₚ) and run Uverify(pk_{U}, sₚ, p). Output b=0 if it rejects. Otherwise parse p as (i [symbol] ′, fee, open_{fee}, {scᵢ, dᵢ, c_{cons}ᵢ, cₒₜₕₑᵣᵢ, c_{price}ᵢ, πᵢ}ᵢ₌₁^{N}), check that i [symbol] =i [symbol] ′ and, for i=1 to N, increment d_{P} and run Mverify(pk_{M}, scᵢ, [symbol] d_{P}, c_{cons}_{ᵢ}, cₒₜₕₑᵣ_{ᵢ} [symbol] ). Output b=0 if any of the signatures or the proofs is not correct. Compute commitments to the prices c_{price}_{ᵢ}=(c_{cons}_{ᵢ} e a₁) \textcircled{×}Commit(par_{c}, a₀, 0), add them c_{fee}=\textcircled{×}ᵢ₌₁^{N}c_{price}_{ᵢ} and execute Open(par_{c}, c′_{fee}, fee, open_{fee}). If the output is accept, set b=1 and otherwise b=0. Output (b, d_{P}).

Security of this scheme relies on the unforgeability of the signature schemes and on the binding and hiding properties of the commitment schemes. The policy identifier i [symbol] is introduced to ensure that U and P employ the policy published previously by P to compute and verify the payment message

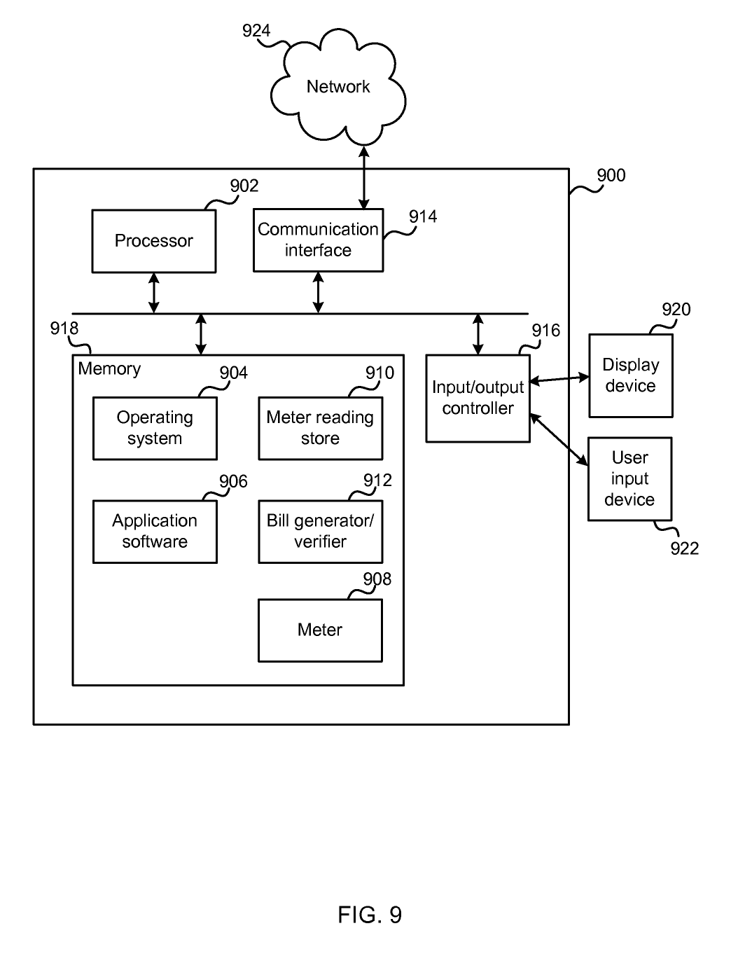

FIG. 9 illustrates various components of an exemplary computing-based device 900 which may be implemented as any form of a computing and/or electronic device, and in which embodiments of an entity in a privacy preserving metering system may be implemented. For example, a smart meter, a bill generator, or a bill verifier.

Computing-based device 900 comprises one or more processors 902 which may be microprocessors, controllers or any other suitable type of processors for processing computing executable instructions to control the operation of the device in order to provide at least part of a privacy preserving metering system. For example, by providing a smart meter incorporating a bill generator, a bill generator able to generate a privacy preserving bill and a zero knowledge proof to certify that bill, or a bill verifier able to verify a bill that is provided together with a zero knowledge proof certifying that bill. Platform software comprising an operating system 904 or any other suitable platform software may be provided at the computing-based device to enable application software 906 to be executed on the device.

The computer executable instructions may be provided using any computer-readable media that is accessible by computing based device 900. Computer-readable media may include, for example, computer storage media such as memory 918 and communications media. Computer storage media, such as memory 918, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device. In contrast, communication media may embody computer readable instructions, data structures, program modules, or other data in a modulated data signal, such as a carrier wave, or other transport mechanism. Although the computer storage media (memory 918) is shown within the computing-based device 900 it will be appreciated that the storage may be distributed or located remotely and accessed via a network or other communication link (e.g. using communication interface 914).

The computing based device comprises a communication interface 914 which enables it to communicate with other entities over a communications network 924.

The computing-based device 900 also comprises an input/output controller 916 arranged to output display information to a display device 920 which may be separate from or integral to the computing-based device 900. The display information may provide a graphical user interface. The input/output controller 916 is also arranged to receive and process input from one or more devices, such as a user input device 922 (e.g. a mouse or a keyboard). This user input may be used to control the device in order to generate privacy preserving bills or to verify such bills. In embodiments where the device is a smart meter the user input may be used to control use of a resource being metered by the smart meter. In an embodiment the display device 920 may also act as the user input device 922 if it is a touch sensitive display device. The input/output controller 916 may also output data to devices other than the display device, e.g. a locally connected printing

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A privacy-preserving billing system comprising one or more computing devices arranged to implement at least the following components:
an input component arranged to receive, during a billing period, certified meter readings indicating a consumption of a utility, good or service by a user from a meter arranged to measure the consumption of the utility, good or service by the user;
a certified pricing policy store arranged to hold at least one certified pricing policy as a plurality of table rows, and at least one signature of at least one of the plurality of table rows signed by a provider of the utility, good or service, the certified pricing policy indicating pricing of consumption of the utility, good or service;
a bill generator arranged to generate a bill based at least in part on the certified pricing policy and the certified meter readings, the bill comprising a total fee for consumption during the billing period and omitting the certified meter readings;
a proof engine arranged to generate a non-interactive zero knowledge proof showing that the bill is formed from the certified meter readings and the certified pricing policy, the zero knowledge proof comprising challenges and responses to prove possession of the signatures on the table rows used to compute the total fee;
a verifier arranged to receive the bill and non-interactive zero knowledge proof; the verifier being arranged to verify the zero knowledge proofs by computing commitments given the challenges and responses of the non-interactive zero knowledge proof and based at least in part on the responses, calculating a second challenge and checking if the second challenge equals a first challenge of the challenges of the zero knowledge proof without gaining any knowledge of the certified meter readings.

2. A privacy-preserving billing system as claimed in claim 1 wherein the bill generator is arranged to send a signed message to the verifier comprising the non-interactive zero knowledge proof challenges and responses and commitments to fragments of the pricing policy used to compute the total fee and commitments to the meter readings and wherein the verifier is arranged to link the commitments in the signed message to a commitment to a cost per meter reading.

3. A privacy-preserving billing system as claimed in claim 1 wherein the bill generator is arranged to send a signed message to the verifier comprising commitments to costs associated with individual meter readings and wherein the verifier is arranged to check that a combination of the commitments to those costs is the same as a commitment to the total fee.

4. A privacy-preserving billing system as claimed in claim 1 wherein the bill generator is arranged to send a signed message to the verifier comprising commitments to the meter readings and wherein the verifier accesses the number of meter readings expected during the billing period and wherein the verifier checks that the expected number of meter readings were used to compute the total fee and that those meter readings are sequential.

5. A privacy-preserving billing system as claimed in claim 1 wherein the verifier is arranged to send a request to the bill generator to reveal some specified meter readings and wherein the bill generator is arranged to reveal the specified meter readings only if authorized by the user.

6. A computer-implemented method of generating a bill for consumption of a utility, good or service provided by a provider, the method comprising:
receiving, during a billing period, a certified meter reading from a meter arranged to measure consumption of the utility, good or service by a user, the meter reading indicating the consumption by the user of the utility, good or service;
receiving a certified pricing policy from the provider, the certified pricing policy indicating pricing for a consumption of the utility, good or service;
generating a bill based at least in part of the certified pricing policy and the certified meter reading, the bill comprising a total fee for consumption during the billing period and omitting the certified meter readings;
generating a proof showing that the bill is formed from the certified meter reading and the certified pricing policy; the proof being universally verifiable without revealing the certified meter reading.

7. A method as claimed in claim 6 wherein the proof is a non interactive zero knowledge proof in which a prover can prove a statement in zero knowledge to a verifier, without the need for the verifier to send any information to the prover.

8. A method as claimed in claim 7 comprising generating the proof using signatures on parts of the certified pricing policy that map the meter reading to fees and wherein the proof comprises a zero-knowledge proof of possession of those signatures.

9. A method as claimed in claim 6 wherein the meter is trusted by an entity which generates the bill not to leak any more information than the meter readings.

10. A method as claimed in claim 6 which comprises sending a signed message to a verifier comprising the bill, the proof, commitments to fragments of the pricing policy used to compute the bill and a commitment to the meter reading.

11. A method as claimed in claim 6 wherein the certified meter reading includes one or more signed commitments to the meter readings together with openings to those commitments where the openings to the commitments are parameters which enable the commitments to the meter readings to be revealed.

12. A method as claimed in claim 11 comprising signing and sending a payment message to the provider, the payment message comprising at least challenges and responses of the proof, a commitment to the total fee, an opening to the commitment to the total fee, commitments to fragments of the pricing policy used to compute the total fee and commitments to the meter readings; where a commitment is a value to be sent in a hidden form to a receiver in such a manner that the sender is unable to change the hidden value before it is revealed to the receiver.

13. A method as claimed in claim 12 comprising receiving the certified pricing policy as a pricing policy that has been signed by the provider using a signature scheme which enables efficient proofs of signature possession.

14. A method as claimed in claim 6, wherein the meter reading includes a plurality of meter readings, and receiving the certified pricing policy includes receiving and storing the certified pricing policy as a plurality of signed table rows each table row mapping a specific meter reading of the plurality of meter readings to a fee of the certified pricing policy; and wherein generating the proof includes generating the proof to include a zero knowledge proof of possession of the signatures on the table rows used to generate the total fee and a zero knowledge proof of equality between the values in the signed table rows used to generate the total fee and a value in a commitment to the total fee of the bill where a commitment is a value to be sent in a hidden form to a receiver in such a manner that the sender is unable to change the hidden value before it is revealed to the receiver.

15. A method as claimed in claim 6, wherein receiving the certified pricing policy includes receiving the certified pricing policy as a plurality of signed table rows each table row mapping a specific meter reading to a fee per unit of consumption; and wherein generating the proof includes generating the proof to include a zero knowledge proof of possession of the signatures on the table rows used to generate the total fee of the bill, a zero knowledge proof of equality, and a zero knowledge proof that a value in a commitment to the total fee equals consumption values of the certified meter reading multiplied by the fees per unit of consumption of the certified pricing policy.

16. A method as claimed in claim 6 wherein receiving the certified pricing policy includes receiving the certified pricing policy as a plurality of signed table rows each table row mapping a range of consumption values to a fee; and wherein generating the proof includes generating the proof to include, for each meter reading, a zero knowledge proof of possession of a signature on the appropriate table row, a zero knowledge proof that the meter reading consumption value is in the range of consumption values for the signed table row, and a zero knowledge proof of equality between the fee in the signed table row and a value in a commitment to the fee.

17. A method as claimed in claim 6 wherein receiving and storing the certified pricing policy includes receiving and storing the certified pricing policy as a plurality of signed table rows each table row mapping a range of consumption values to a fee per unit of consumption; and wherein generating the proof includes generating the proof to include, for each meter reading, a zero knowledge proof of possession of a signature on the appropriate table row, a zero knowledge proof that the meter reading consumption value is in the range of consumption values for the signed table row, a zero knowledge proof that a value in a commitment to the fee equals the consumption value of the meter reading multiplied by the fee per unit of consumption, and another zero knowledge proof of equality; where a commitment is a value to be sent in a hidden form to a receiver in such a manner that the sender is unable to change the hidden value before it is revealed to the receiver

18. A method as claimed in claim 6 wherein receiving and storing the certified pricing policy includes receiving and storing the certified pricing policy as a plurality of signed table rows each table row comprising a polynomial function mapping a range of consumption values to a fee; where a commitment is a value to be sent in a hidden form to a receiver in such a manner that the sender is unable to change the hidden value before it is revealed to the receiver.

19. A computer-implemented method of verifying a bill for consumption of a utility, good or service, the method comprising:
receiving a signed payment message comprising the bill having a total price and omitting consumption values; and a non-interactive zero knowledge proof certifying the bill, that proof comprising a first challenge and response;
verifying the signature on the payment message using a digital signature scheme;
verifying the zero-knowledge proof by computing commitments given the challenges and responses and calculating a second challenge and checking if the second challenge equals the first challenge received in the payment message without finding consumption values used to calculate the total price.

20. A method as claimed in claim 19 wherein the signed payment message includes commitments to meter readings used to calculate the bill; the method further comprising accessing an expected number of meter readings and checking that the number of commitments in the payment message equals the expected number of meter readings and that the commitments to the meter readings used to calculate the bill are sequential.
